(19) United States
(12) Patent Application Publication
(10) Pub. No.: US 2025/0158112 A1
(43) Pub. Date: May 15, 2025

(54) BINDER COMPOSITION FOR ALL-SOLID-STATE BATTERY

(71) Applicant: OTSUKA CHEMICAL CO., LTD., Osaka-city, Osaka (JP)

(72) Inventors: Mizuki Ito, Tokushima-city, Tokushima (JP); Hiroyoshi Mori, Tokushima-city, Tokushima (JP)

(73) Assignee: OTSUKA CHEMICAL CO., LTD., Osaka-city, Osaka (JP)

(21) Appl. No.: 18/835,911

(22) PCT Filed: Jan. 27, 2023
(86) PCT No.: PCT/JP2023/002562

§ 371 Date: Aug. 5, 2024

(30) Foreign Application Priority Data
Feb. 8, 2022 (JP) 2022-018035

(51) Int. Cl. H01M 10/0562; C01G 23/047; H01M 10/0525

(52) U.S. Cl. CPC H01M 10/0562; C01G 23/047; H01M 10/0525; H01M 2300/0071

(57) ABSTRACT

Provided is a binder composition for an all-solid-state battery in which an inorganic binder component is used and which enables the formation of a solid electrolyte layer capable of allowing an all-solid-state battery to exert excellent ionic conductivity. A binder composition for an all-solid-state battery is used in formation of an all-solid-state battery and contains a flaky metal acid compound, wherein the flaky metal acid compound is composed of: a flaky metal acid; and a basic compound and/or a lithium salt.

### TECHNICAL FIELD

The present invention relates to binder compositions for all-solid-state batteries, the binder compositions being used in the formation of all-solid-state batteries.

### BACKGROUND ART

Lithium-ion secondary batteries are used as power sources for portable devices, such as notebook personal computers, tablet terminals, mobile phones, and handy video cameras, because they have excellent energy density and power density and are effective in size reduction and weight reduction. Lithium-ion secondary batteries are also attracting attention as power sources for electric vehicles.

In conventional lithium-ion secondary batteries, an electrolytic solution containing a combustible organic solvent is used. Therefore, a short circuit may occur inside the batteries due to liquid leakage or excessive charging/discharging and, thus, the batteries may cause burning or explosion. For this reason, lithium-ion secondary batteries are required to be fitted with a safety device for suppressing a temperature increase during occurrence of a short circuit and to be improved in structure and material for the purpose of preventing the occurrence of a short circuit. Under these circumstances, all-solid-state batteries in which a solid electrolyte is used instead of an electrolytic solution containing a combustible organic solvent have attracted attention. In all-solid-state batteries, all of the negative electrode, electrolyte, and positive electrode are made of solids and, therefore, the safety and the reliability, which would be challenges for batteries using an electrolytic solution, can be significantly improved.

An all-solid-state battery includes a positive electrode, a negative electrode, and a solid electrolyte layer located between the positive electrode and the negative electrode. The electrodes (the positive electrode and the negative electrode) are each formed, for example, by applying a slurry composition containing an electrode active material (a positive-electrode active material or a negative-electrode active material), a binder, and a solid electrolyte material onto a current collector and drying the applied slurry composition to provide an electrode composite material layer (a positive electrode composite material layer or a negative electrode composite material layer) on the current collector. The solid electrolyte layer is formed, for example, by applying a slurry composition containing a binder and a solid electrolyte material onto an electrode or a release base material and drying the applied slurry composition. The material used as the binder is a specific polymer compound or so on. For example, Patent Literature 1 discloses the use of an acrylic polymer as a binder.

### CITATION LIST

### Patent Literature

Patent Literature 1: WO 2020/066951

### SUMMARY OF INVENTION

### Technical Problem

However, polymer compounds as in Patent Literature 1 have low ionic conductivities and low ionic transference numbers. Therefore, even if a solid electrolyte layer is formed using such a polymer compound as a binder composition, the solid electrolyte may fail to exert its true effect. Furthermore, since the polymer compounds are organic materials, there may arise a problem with the storage stability of all-solid-state batteries at high temperatures.

The present invention aims at providing: a binder composition for an all-solid-state battery in which an inorganic binder component is used and which enables the formation of a solid electrolyte layer capable of allowing an all-solid-state battery to exert excellent ionic conductivity; a slurry composition for an all-solid-state battery in which the binder composition for an all-solid-state battery is used; and a lithium-ion secondary battery including a solid electrolyte layer formed using the slurry composition for an all-solid-state battery.

### Solution to Problem

The present invention provides the following binder composition for an all-solid-state battery, the following slurry composition for an all-solid-state battery, and the following all-solid-state battery.

Aspect 1: A binder composition for an all-solid-state battery, the binder composition being used in formation of an all-solid-state battery and containing a flaky metal acid compound, the flaky metal acid compound being composed of: a flaky metal acid; and a basic compound and/or a lithium salt.

Aspect 2: The binder composition for an all-solid-state battery according to aspect 1, wherein the flaky metal acid compound has an average length of not less than 0.5 μm and not more than 50 μm.

Aspect 3: The binder composition for an all-solid-state battery according to aspect 1 or 2, wherein the flaky metal acid is titanic acid.

Aspect 4: The binder composition for an all-solid-state battery according to any one of aspects 1 to 3, wherein the flaky metal acid compound is formed by allowing the basic compound to act on a metal acid having a layered crystal structure to swell and/or peel an interlayer of the layered crystal structure.

Aspect 5: The binder composition for an all-solid-state battery according to any one of aspects 1 to 3, wherein the flaky metal acid compound is formed by allowing the basic compound to act on a metal acid having a layered crystal structure to obtain a compound in which an interlayer of the layered crystal structure is swelled and/or peeled and allowing the lithium salt to act on the obtained compound.

Aspect 6: The binder composition for an all-solid-state battery according to any one of aspects 1 to 5, the binder composition being substantially free of non-ionic conductive polymer compound.

Aspect 7: The binder composition for an all-solid-state battery according to any one of aspects 1 to 6, the binder composition further containing a dispersion medium.

Aspect 8: The binder composition for an all-solid-state battery according to aspect 7, wherein the dispersion medium is at least one selected from the group consisting of water, a lactam solvent, a nitriles solvent, an ethers solvent, a ketones solvent, an esters solvent, and a halogenated solvent.

Aspect 9: The binder composition for an all-solid-state battery according to aspect 7 or 8, wherein a content of the dispersion medium is not less than 100 parts by mass and not more than 10,000 parts by mass relative to 100 parts by mass of the flaky metal acid compound.

Aspect 10: A slurry composition for an all-solid-state battery, the slurry composition containing a solid electrolyte material and the binder composition for an all-solid-state battery according to any one of aspects 7 to 9.

Aspect 11: The slurry composition for an all-solid-state battery according to aspect 10, wherein the solid electrolyte material is an inorganic solid electrolyte material.

Aspect 12. The slurry composition for an all-solid-state battery according to aspect 10 or 11, wherein the solid electrolyte material is: a titanate having a structure in which a plurality of host layers are laid one on top of another, the host layer being formed so that octahedra each formed of a titanium atom coordinated with six oxygen atoms are two-dimensionally chained while sharing ridges, and lithium ions are intercalated in interlayers between the host layers, titanium sites in the host layers being partially substituted by monovalent to trivalent cations; or a titanate having a structure in which a plurality of host layers are laid one on top of another, the host layer being formed so that octahedra each formed of a titanium atom coordinated with six oxygen atoms are two-dimensionally chained while sharing ridges, and lithium ions and divalent or higher-valent cations are intercalated in interlayers between the host layers, titanium sites in the host layers being partially substituted by monovalent to trivalent cations.

Aspect 13: A solid electrolyte layer formed using the slurry composition for an all-solid-state battery according to any one of aspects 10 to 12.

Aspect 14: A lithium-ion secondary battery including the solid electrolyte layer according to aspect 13.

### Advantageous Effects of Invention

The present invention enables provision of: a binder composition for an all-solid-state battery in which an inorganic binder component is used and which enables the formation of a solid electrolyte layer capable of allowing an all-solid-state battery to exert excellent ionic conductivity; a slurry composition for an all-solid-state battery in which the binder composition for an all-solid-state battery is used; and a lithium-ion secondary battery including a solid electrolyte layer formed using the slurry composition for an all-solid-state battery.

### BRIEF DESCRIPTION OF DRAWINGS

FIG. 1 is a schematic cross-sectional view showing a lithium-ion secondary battery according to one embodiment of the present invention.

FIG. 2 is Nyquist diagrams in Examples 1 and 2.

FIG. 3 is Nyquist diagrams in Examples 3 to 5, Comparative Example 2, and Comparative Example 3.

FIG. 4 is Nyquist diagrams showing FIG. 3 on a larger scale.

### DESCRIPTION OF EMBODIMENTS

Hereinafter, a description will be given of an example of a preferred embodiment for working of the present invention. However, the following embodiment is simply illustrative. The present invention is not at all limited by the following embodiment.

<Binder Composition for all-Solid-State Battery>

A binder composition for an all-solid-state battery (hereinafter, also referred to simply as a binder composition) according to the present invention is a binder composition for use in the formation of an all-solid-state battery. The binder composition contains a flaky metal acid compound. The flaky metal acid compound is composed of: a flaky metal acid; and a basic compound and/or a lithium salt (i.e., at least one of a basic compound and a lithium salt). The term “flaky” used herein is a concept encompassing particle shapes called platy, sheet-like, and scaly and means a shape having relatively large ratios of the width and the length to the thickness.

Examples of a metal acid constituting the flaky metal acid include titanic acid, niobic acid, manganic acid, zirconic acid, tungsten acid, molybdenum acid, cobaltic acid, ferric acid, tantalic acid, zincic acid, germanic acid, and ruthenium acid. From the viewpoint of further increasing the ionic conductivity, the flaky metal acid is preferably titanic acid in flake form (flaky titanic acid) and the flaky metal acid compound is preferably a flaky titanic acid compound.

The binder composition for an all-solid-state battery according to the present invention enables the use of an inorganic binder component and enables the formation of a solid electrolyte layer capable of allowing the all-solid-state battery to exert excellent ionic conductivity.

The flaky metal acid compound is a component that has excellent ionic conductivity and functions as a binder for solid particles. When the binder composition containing the flaky metal acid compound is used as a binder for binding solid particles of a solid electrolyte material or so on in an all-solid-state battery, the interfacial resistance between the solid particles and so on can be reduced and the formation of dendrite can be suppressed. An example of the all-solid-state battery is a lithium-ion secondary battery. Furthermore, the flaky metal acid compound is formed of inorganic particles and, therefore, can be expected to increase the storage stability of the all-solid-state battery at high temperatures.

Specific examples of the flaky metal acid compound include: a first flaky metal acid compound formed by allowing a basic compound to act on a metal acid having a layered crystal structure to swell and/or peel the interlayers of the layered crystal structure; and a second flaky metal acid compound formed by allowing a basic compound to act on a metal acid having a layered crystal structure to obtain a compound in which the interlayers of the layered crystal structure are swelled and/or peeled and allowing the lithium salt to act on the obtained compound. From the viewpoint of further increasing the thermal resistance, the flaky metal acid compound is preferably the second flaky metal acid compound.

The average length of the flaky metal acid compound is preferably not less than 0.5 μm, more preferably not less than 1 μm, preferably not more than 50 μm, more preferably not more than 30 μm, even more preferably not more than 20 μm, and particularly preferably not more than 10 μm. When the average length of the flaky metal acid compound is within the above range, gaps between the solid electrolyte particles can be more certainly filled in, the grain boundary resistance can be further reduced, and the formation of dendrite can be further suppressed. The average length means the particle diameter of the flaky metal acid compound along the plane perpendicular to the thickness direction thereof. The average length can be measured, for example, by observation with an electron microscope, such as a transmission electron microscope (TEM) or a scanning electron microscope (SEM). Specifically, the average length can be measured with a sample produced by adding the binder composition dropwise to a carbon tape and drying it. The average length may be, for example, an average of particle diameters of 100 particles of the flaky metal acid compound measured in the above manner.

The average length of the flaky metal acid compound substantially maintains the average length of source material particles, such as a source titanate to be described hereinafter, unless the source material particles are subjected to stirring with a strong shear force in the process of allowing a basic compound to act on the source material particles to cause interlayer peeling.

The average thickness of the flaky metal acid compound is not particularly limited so long as it is thinner than the particle thickness of the metal acid having a layered crystal structure. However, for example, when the flaky metal acid is titanic acid, the average thickness of the flaky metal acid compound is preferably not less than 0.75 nm, more preferably not less than 1.0 nm, preferably not more than 500 nm, and more preferably not more than 300 nm. When the average thickness of the flaky metal acid compound is within the above range, gaps between the solid electrolyte particles can be more certainly filled in, the grain boundary resistance can be further reduced, and the formation of dendrite can be further suppressed. The average thickness of the flaky metal acid compound can be measured, like the average length, by observation with an electron microscope, such as a TEM or a SEM. Furthermore, the average thickness may be, for example, an average of particle thicknesses of 100 particles of the flaky metal acid compound measured in the above manner. For example, when the flaky metal acid is titanic acid, the thickness per single-layer nanosheet of the metal acid is 0.75 nm.

The ratio of average length to average thickness ((average length)/(average thickness)) of the flaky metal acid compound is preferably not less than 1, more preferably not less than 5, preferably not more than 50,000, and more preferably not more than 30,000. When the ratio ((average length)/(average thickness)) is within the above range, gaps between the solid electrolyte particles can be more certainly filled in, the grain boundary resistance can be further reduced, and the formation of dendrite can be further suppressed.

The flaky metal acid compound is preferably single-layer metal acid nanosheets in which a metal acid having a layered crystal structure is completely peeled, but the flaky metal acid compound may be 2-layered to 300-layered laminates of metal acid nanosheets. The laminates of metal acid nanosheets are preferably 10-layered to 300-layered laminates of metal acid nanosheets. Alternatively, the flaky metal acid compound may be formed of a mixture of single-layer metal acid nanosheets and laminates of metal acid nanosheets. However, in this case, the flaky metal acid compound is preferably a mixture having an average thickness falling within the above range.

The binder composition according to the present invention is preferably substantially free of non-ionic conductive polymer compound from the viewpoint of further increasing the storage stability at high temperatures and the ionic conductivity of the all-solid-state battery. The expression “substantially free of” means that the content of the relevant material in a total amount of 100% by mass of binder composition is not more than 3% by mass, preferably not more than 1% by mass, and more preferably 0% by mass.

The term “non-ionic conductive polymer compound” herein refers to a polymer in which a main chain and/or a side chain has no ionic dissociation group. The term “ionic dissociation group” refers to: a group capable of ionizing itself, such as a hydroxy group, a carboxy group, a sulfonic acid group or a phosphoric acid group; and a group capable of ionizing a salt of an electrolyte or like substance capable of being ionized, such as an alkylene oxide group or an alkylene imine group.

Specific examples of the non-ionic conductive polymer compound include: synthetic rubbers, such as polytetrafluoroethylene (PTFE), polyvinylidene fluoride (PVDF), polyvinylidene fluoride-hexafluoropropylene copolymer (PVDF-HFP), butadiene rubber, styrene-butadiene rubber (SBR), styrene-butadiene-styrene copolymer (SBS), styrene-ethylene-butylene-styrene copolymer (SEBS), ethylene-propylene rubber, butyl rubber, chloroprene rubber, acrylonitrile-butadiene rubber, acrylic rubber, silicone rubber, fluoro-rubber, and urethane rubber; polyimide; polyamide; polyamide imide; and chlorinated polyethylene (CPE). The weight-average molecular weight of the non-ionic conductive polymer compound is 2000 or more and its upper limit is not particularly limited, but is preferably 1,000,000.

The binder composition according to the present invention may further contain a dispersion medium. When the binder composition contains a dispersion medium, a slurry composition for use in the formation of a solid electrolyte layer or the like can be more easily produced.

The content of the dispersion medium in the binder composition according to the present invention is sufficient to be an amount into which the flaky metal acid compound can be stably dispersed. The content of the dispersion medium is, relative to 100 parts by mass of the flaky metal acid compound, for example, preferably not less than 100 parts by mass, more preferably not less than 200 parts by mass, preferably not more than 10,000 parts by mass, and more preferably not more than 1,000 parts by mass.

Examples of the dispersion medium that can be used include: water; a lactam solvent, such as N-methyl-2-pyrrolidone; a nitriles solvent, such as acetonitrile; an ethers solvent, such as tetrahydrofuran; a ketones solvent, such as methyl ethyl ketone; an esters solvent, such as ethyl acetate; and a halogenated solvent, such as methylene dichloride, chloroform, carbon tetrachloride, dichloroethane, trichloroethylene, perchloroethylene, and ortho-dichlorobenzene. These dispersion media may be used singly or in combination of two or more of them. Furthermore, the dispersion medium to be used may be appropriately selected from among the above dispersion media according to the intended use of the binder composition. For example, when a slurry composition for use in the formation of a solid electrolyte layer or so on is an aqueous slurry, at least one selected from the group consisting of water, a lactam solvent, a nitriles solvent, and an ethers solvent can be used as the dispersion medium. For another example, when a slurry composition for use in the formation of a solid electrolyte layer or so on is a non-aqueous slurry, at least one selected from the group consisting of a lactam solvent, a nitriles solvent, an ethers solvent, a ketones solvent, an esters solvent, and a halogenated solvent can be used.

### (Metal Acid Having Layered Crystal Structure)

Examples of the metal acid having a layered crystal structure include titanic acid, niobic acid, manganic acid, zirconic acid, tungsten acid, molybdenum acid, cobaltic acid, ferric acid, tantalic acid, zincic acid, germanic acid, and ruthenium acid and the preferred metal acid is titanic acid. Titanic acid having a layered crystal structure can be obtained, for example, by subjecting a titanate having a layered crystal structure (hereinafter, referred to as a “source titanate”) to acid treatment. By this acid treatment, cations by which some of the titanium sites in host layers have been substituted and cations between the host layers are substituted by hydrogen ions or hydronium ions as the layered structure of the source titanate to be described hereinafter remains maintained, and, as a result, titanic acid having a layered crystal structure can be produced. The term titanic acid used here includes a hydrated titanic acid in which water molecules are present in the interlayers.

Examples of acid for use in the acid treatment include mineral acids, such as hydrochloric acid, sulfuric acid, nitric acid, phosphoric acid, and boric acid; and organic acids. Among them, mineral acids are preferred as acids for use in the acid treatment.

The acid treatment is preferably performed under a wet condition. The acid treatment can be performed, for example, by adding an acid directly into a suspension containing a source titanate dispersed into water or adding a dilution of the acid with water into the suspension, and stirring the mixture to induce a reaction. The reaction temperature is preferably 5° C. to 80° C. and the reaction time is preferably an hour to three hours. After the reaction, a solid is separated from the reactant by suction filtration, centrifugation or other methods and washed in water. Thus, titanic acid having a layered crystal structure can be obtained.

The exchange rate of cations can be controlled by appropriately adjusting the type and concentration of the acid and the concentration of the source titanate according to the type of the source titanate. Furthermore, the exchange rate of cations is preferably 20% to 100% and more preferably 75% to 100% relative to the volume of exchangeable cations in the source titanate from the viewpoint of interlayer peeling. The term “volume of exchangeable cations” refers to, for example, a value represented by x+my when a source titanate is represented by a general formula AₓM_{y}Ti_{(2-y)}O₄ [where A is at least one of alkali metals except for Li, M is at least one selected from among Li, Mg, Zn, Ga, Ni, Cu, Fe, Al, and Mn, x is a number from 0.5 to 1.0, and y is a number from 0.25 to 1.0] and m represents the valence of M.

If the amount of cations remaining in the interlayers is large, interlayer peeling is less likely to occur and, thus, the thickness of the flaky titanic acid compound after the peeling becomes large. In the case where cations are difficult to remove, the acid treatment may be repeated as necessary.

### Source Titanate;

An example of the source titanate is a lepidocrocite titanate having a structure in which a plurality of host layers are laid one on top of another, the host layer being formed so that octahedra each formed of a titanium atom coordinated with six oxygen atoms are two-dimensionally chained while sharing ridges, and cations, such as alkali metal ions, are intercalated in interlayers between the host layers, titanium sites in the host layers being partially substituted by monovalent to trivalent cations.

The host layer is formed so that octahedra each formed of a titanium atom coordinated with six oxygen atoms are two-dimensionally chained while sharing ridges, and forms a single layer serving as a unit of the layered structure (laminate). The individual host layer is originally electrically neutral, but is negatively charged since its tetravalent titanium sites are partially substituted by monovalent to trivalent cations or are partially vacant.

Specific examples of the source titanate include AₓM_{y}Ti_{(2-y)}O₄ [where A is at least one of alkali metals except for Li, M is at least one selected from among Li, Mg, Zn, Ga, Ni, Cu, Fe, Al, and Mn, x is a number from 0.5 to 1.0, and y is a number from 0.25 to 1.0], A_{0.2-0.8}Li_{0.2-0.4}Ti_{1.73}O_{3.85-3.95} [where A is at least one of alkali metals except for Li], A_{0.2-0.8}Mg_{0.3-0.5}Ti_{1.6}O_{3.7-3.95} [where A is at least one of alkali metals except for Li], and A_{0.5-0.7}Li_{(0.27-x)}MyTi_{(1.73-z)}O_{3.85-3.95} [Where: A is at least one of alkali metals except for Li; M is at least one selected from among Mg, Zn, Ga, Ni, Cu, Fe, Al, and Mn (except for combinations of different types of ions having different valences in using two or more types of ions); x=2y/3 and z=y/3 when M is a divalent metal; x=y/3 and z=2y/3 when M is a trivalent metal; and 0.004≤y≤0.4]. The preferred source titanate is at least one selected from the group consisting of A_{0.5-0.7}Li_{0.27}Ti_{1.73}O_{3.85-3.95} [where A is at least one of alkali metals except for Li] and A_{0.2-0.7}Mg_{0.40}Ti_{1.6}O_{3.7-3.95} [where A is at least one of alkali metals except for Li].

The source titanate is formed of powdered particles, including spherical particles (inclusive of particles of a spherical shape with some asperities on its surface and particles of an approximately spherical shape, such as those having an elliptic cross-section), bar-like particles (inclusive of particles of an approximately bar-like shape as a whole, such as rodlike, columnar, prismoidal, reed-shaped, approximately columnar, and approximately reed-shaped particles), platy particles, blocky particles, particles of a shape with multiple projections (such as amoeboid, boomerang-like, cross, or kompeito-like shape), and particles of an irregular shape. Among them, platy particles are preferred as particles of the source titanate.

### (First Flaky Metal Acid Compound)

The first flaky metal acid compound can be obtained by allowing a basic compound to act on a metal acid having a layered crystal structure to swell and/or peel the interlayers of the layered crystal structure.

The type of the basic compound is not particularly limited so long as it has an interlayer swelling effect of a metal acid having a layered crystal structure, and examples thereof include primary to tertiary organic amines, organic ammonium salts, and organic phosphonium salts. Among them, primary to tertiary organic amines and quaternary organic ammonium salts are preferred. The basic compounds may be used singly or in combination of two or more of them.

Examples of the primary organic amines include methylamine, ethylamine, n-propylamine, butylamine, pentylamine, hexylamine, octylamine, dodecylamine, 2-ethylhexylamine, 3-methoxypropylamine, 3-ethoxypropylamine, octadecylamine, and their salts. From the viewpoint of interlayer peeling, primary organic amines having two to four carbon atoms are preferred.

Examples of the secondary organic amines include diethylamine, dipentylamine, dioctylamine, dibenzylamine, di(2-ethylhexyl)amine, di(3-ethoxypropyl)amine, and their salts. From the viewpoint of interlayer peeling, secondary organic amines having two to eight carbon atoms are preferred.

Examples of the tertiary organic amines include triethylamine, trioctylamine, tri (2-ethylhexyl)amine, tri (3-ethoxypropyl)amine, dipolyoxyethylenedodecylamine, dimethyldecylamine, triethanolamine, N, N-dimethylethanolamine and their salts. From the viewpoint of interlayer peeling, tertiary organic amines having three to twelve carbon atoms are preferred.

Examples of the quaternary organic ammonium salts include dodecyltrimethylammonium salts, cetyltrimethylammonium salts, stearyltrimethylammonium salts, benzyltrimethylammonium salts, benzyltributylammonium salts, trimethylphenylammonium salts, dimethyldistearylammonium salts, dimethyldidecylammonium salts, dimethylstearylbenzylammonium salts, dodecyl bis(2-hydroxyethyl)methylammonium salts, trioctylmethylammonium salts, and dipolyoxyethylenedodecylmethylammonium salts. From the viewpoint of interlayer peeling, quaternary organic ammonium salts having four to sixteen carbon atoms are preferred.

Examples of the organic phosphonium salts include tetrabutylphosphonium salts, hexadecyltributylphosphonium salts, dodecyltributylphosphonium salts, and dodecyltriphenylphosphonium salts.

In order to allow a basic compound to act on a metal acid having a layered crystal structure, normally, the basic compound is added directly into a suspension containing the metal acid dispersed into an aqueous medium or the basic compound dissolved in an aqueous medium is added into the suspension, and the mixture is stirred to induce a reaction. The reaction temperature is preferably 20° C. to 85° C. and the reaction time is preferably 1 hour to 24 hours. After the reaction, a solid is separated from the reactant by suction filtration, centrifugation or other methods and washed in an aqueous medium. Thus, a first flaky metal acid compound can be obtained.

Examples of the “aqueous medium” herein include water, organic solvents miscible with water, and mixtures of them. Examples of the water-miscible organic solvents include: alcohols solvents, such as methyl alcohol, ethyl alcohol, and isopropyl alcohol; lactam solvents, such as N-methyl-2-pyrrolidone; nitriles solvents, such as acetonitrile; and ethers solvents, such as tetrahydrofuran. On the other hand, examples of a “non-aqueous medium” include organic solvents phase-separable from water. Examples of the non-aqueous medium include: aliphatic or alicyclic hydrocarbons solvents, such as n-hexane, n-heptane, n-octane, and cyclohexane; aromatic hydrocarbon solvents, such as benzene, toluene, xylene, and ethylbenzene; halogenated solvents, such as methylene dichloride, chloroform, carbon tetrachloride, dichloroethane, trichloroethylene, perchloroethylene, and ortho-dichlorobenzene; ketones solvents, such as methyl ethyl ketone; esters solvents, such as ethyl acetate.

In producing the first flaky metal acid compound, an aqueous solvent for use may be water, a mixture of water and a water-miscible organic solvent, or a water-miscible organic solvent. Among them, water is preferably used as the aqueous solvent from the viewpoint of further increasing reactivity.

The amount of the basic compound added is, relative to the volume of exchangeable cations in the metal acid having a layered crystal structure, preferably 1.0 to 2.5 equivalents and more preferably 1.1 to 2.0 equivalents. If the amount of the basic compound added is smaller than the above lower limit, uniform interlayer peeling may be less likely to occur. On the other hand, if the amount of the basic compound added is larger than the above upper limit, this may be economically inadvisable.

The degree of peeling of the metal acid having a layered crystal structure can be controlled by appropriately selecting the type and usage of the basic compound to be used, the concentration of the metal acid having a layered crystal structure, and other conditions. Thus, the resultant first flaky metal acid compound can be controlled to have a desired thickness. Generally, as the concentration of the metal acid having a layered crystal structure is higher, interlayer peeling is less likely to occur and, therefore, the thickness of the flaky titanic acid compound after the peeling becomes larger. The concentration of the metal acid having a layered crystal structure is preferably about 3% by mass.

### (Second Flaky Metal Acid Compound)

The second flaky metal acid compound can be obtained by allowing a lithium salt to act on the first flaky metal acid compound.

By allowing a lithium salt to act on the first flaky metal acid compound, the basic compound in the first flaky metal acid compound is substituted by lithium ions. This substitution reaction is preferably performed under a wet condition. For example, the substitution reaction is performed by adding a lithium salt directly into a suspension containing the first flaky metal acid compound dispersed into an aqueous solvent or adding a lithium salt dissolved in an aqueous solvent into the suspension, and stirring the mixture to induce a reaction. The reaction temperature is preferably 20° C. to 85° C. and the reaction time is preferably 1 hour to 24 hours. After the reaction, a solid is separated from the reactant by suction filtration, centrifugation or other methods and washed in an aqueous solvent. Thus, a second flaky metal acid compound can be obtained. Alternatively, the suspension after the reaction may be obtained as a binder composition according to the present invention.

In producing the second flaky metal acid compound, the aqueous solvent is preferably water. When the first flaky metal acid compound is treated with a surface treatment agent to be described later, the aqueous solvent is preferably a lactam solvent.

Examples of the lithium salt include lithium hydroxide monohydrate, lithium chloride, lithium bis(trifluoromethane sulfonyl)imide, lithium perchlorate, and lithium hexafluorophosphate, and the preferred lithium salts are lithium hydroxide monohydrate and lithium bis(trifluoromethane sulfonyl)imide. The amount of the lithium salt added is, relative to the volume of exchangeable cations in the metal acid having a layered crystal structure, preferably 1 to 3 equivalents and more preferably 1.5 to 2.5 equivalents. If the amount of lithium salt added is smaller than 1 equivalent relative to the volume of exchangeable cations in the metal acid having a layered crystal structure, the lithium salt may not sufficiently be substituted by lithium ions. If the amount of lithium salt added is larger than 3 equivalents relative to the same, this may be economically inadvisable.

Examples of the above-described second flaky metal acid compound include those expressed by a general formula K_{0-0.20}Li_{0.28-1.07}Ti_{1.73}O_{3.6-4} and the preferred second flaky metal acid compounds are K_{0.01-0.10}Li_{0.30-1.0}Ti_{1.73}O_{3.7-3.9}.

Alternatively, in producing the second flaky metal acid compound, the first flaky metal acid compound treated with a surface treatment agent may be used. In other words, a lithium salt may be allowed to act on the first flaky metal acid compound treated with a surface treatment agent.

The surface treatment agent is preferably at least one phosphorus-containing compound selected from the group consisting of phosphate ester, organophosphonic acid, and phosphonate ester. Condensation reaction occurs between a hydroxy group or hydrocarbon oxy group binding directly to a phosphorus atom contained in the phosphorus-containing compound and a hydroxy group or others on the particle surfaces of the first flaky metal acid compound and between hydroxy groups or hydrocarbon oxy groups binding directly to respective phosphorus atoms of two phosphorus-containing compounds, and, as a result, the surfaces of particles of the first flaky metal acid compound are modified (surface-treated) with the phosphorus-containing compound. A phosphorus-containing compound represented by the following formula (1) or (2) is preferably used as the surface treatment agent.

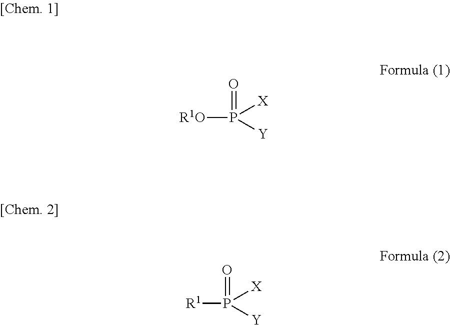

In the formulae, RI represents a hydrocarbon group, X represents a hydroxy group or a hydrocarbon oxy group, and Y represents a hydroxy group, a hydrocarbon group or a hydrocarbon oxy group.

Examples of the hydrocarbon group as RI include an alkyl group and an alkenyl group and the number of carbon atoms of the hydrocarbon group is preferably 12 to 20 from the viewpoint of giving the first flaky metal acid compound hydrophobicity.

Examples of the hydrocarbon oxy group as X and Y include an alkoxy group, an alkenyloxy group, and an allyloxy group. Particularly, the number of carbon atoms of the hydrocarbon oxy group is preferably 1 to 18.

Examples of the hydrocarbon group as Y include an alkyl group, an allyl group, and a vinyl group. Particularly, the number of carbon atoms of hydrocarbon in the hydrocarbon group as Y is preferably 1 to 18.

The group represented by Y in the above formula (1) or (2) can be appropriately selected according to the purpose. In order to increase the reactivity of the above-described condensation reaction, the group represented by Y in the formula (1) or (2) is preferably a hydroxy group.

Specific examples of the phosphorus-containing compound include: phosphate esters, such as dodecenyl phosphate, tridecenyl phosphate, tetradecenyl phosphate, pentadecenyl phosphate, hexadecenyl phosphate, heptadecenyl phosphate, octadecenyl phosphate, oleyl phosphate, octadecadienyl phosphate, octadecatrienyl phosphate, and dioleyl phosphate; organophosphonic acids, such as dodecenylphosphonic acid, tridecenylphosphonic acid, tetradecenylphosphonic acid, pentadecenylphosphonic acid, hexadecenylphosphonic acid, heptadecenylphosphonic acid, octadecenylphosphonic acid, oleylphosphonic acid, octadecadienylphosphonic acid, octadecatrienylphosphonic acid, and dioleylphosphonic acid; and phosphonate esters, such as dodecenyl phosphonate, tridecenyl phosphonate, tetradecenyl phosphonate, pentadecenyl phosphonate, hexadecenyl phosphonate, heptadecenyl phosphonate, octadecenyl phosphonate, and oleyl phosphonate. Among them, phosphate esters are preferably used. And among phosphate esters, oleyl phosphate is particularly preferably used from the viewpoint of ready availability and thermal resistance. The above surface treatment agents may be used singly or in combination of two or more of them.

The treatment of the first flaky metal acid compound with a surface treatment agent is preferably performed under a wet condition. For example, the surface treatment is performed by adding a surface treatment agent directly into a suspension containing the first flaky metal acid compound dispersed into an aqueous solvent or adding a surface treatment agent dissolved in a non-aqueous solvent into the suspension, and stirring the mixture to induce a reaction. Furthermore, for the purpose of stabilizing the suspension, an acid, such as formic acid, acetic acid, hydrochloric acid or nitric acid, an alkali, or other components may be added into the suspension. The reaction temperature is preferably 20° C. to 85° C. and the reaction time is preferably 24 hours to 120 hours. After the reaction, the suspension of the metal acid compound is recovered or, in the case of the reaction using a two-phase system including an aqueous solvent and a non-aqueous solvent, the non-aqueous solvent phase is recovered. Then, a solid is separated from the suspension or non-aqueous solvent phase by suction filtration, centrifugation or other methods and, as necessary, washed in a non-aqueous solvent. Thus, a surface-treated first flaky metal acid compound can be obtained.

The amount of the surface treatment agent in surface-treating the first flaky metal acid compound is not particularly limited, but is, for example, preferably 200 parts by mass to 1,000 parts by mass relative to 100 parts by mass of the first flaky metal acid compound.

By treating the first flaky metal acid compound for use in lithium ion exchange with a surface treatment agent, the affinity of the first flaky metal acid compound for a non-aqueous solvent can be increased and, as a result, the flaky metal acid compound can be easily mixed with a non-aqueous slurry.

### <Slurry Composition for All-Solid-State Battery>

A slurry composition for an all-solid-state battery (hereinafter, also referred to simply as a slurry composition) according to the present invention contains a solid electrolyte material and, as necessary, the above-described binder composition containing a dispersion medium. In other words, the slurry composition according to the present invention is a composition formed by dispersing at least a solid electrolyte material and the above-described flaky metal acid compound in a dispersion medium and, as necessary, may further contain other additives. Furthermore, the slurry composition according to the present invention is preferably substantially free of non-ionic conductive polymer compound from the viewpoint of further increasing the storage stability at high temperatures and the ionic conductivity of the all-solid-state battery. The expression “substantially free of” means that the content of the relevant material in a total amount of 100% by mass of slurry composition is not more than 3% by mass, preferably not more than 1% by mass, and more preferably 0% by mass. Examples of the non-ionic conductive polymer compound include those given as examples in relation to the above-described binder composition.

Since the slurry composition according to the present invention is prepared using the above-described binder composition according to the present invention, the slurry composition enables the formation of a solid electrolyte layer capable of allowing an all-solid-state battery, such as a lithium-ion secondary battery, to exert excellent ionic conductivity.

The content of the flaky metal acid compound in the slurry composition is, relative to 100 parts by mass of solid electrolyte material, preferably 1 part by mass or more and more preferably 5 parts by mass or more. The upper limit of the content of the flaky metal acid compound in the slurry composition is not particularly limited, and a larger amount of flaky metal acid compound may be contained in the slurry composition, but the upper limit of the content of the flaky metal acid compound may be, for example, 100 parts by mass.

Examples of the dispersion medium that can be used in the slurry composition include water, a lactam solvent, a nitriles solvent, an ethers solvent, an esters solvent, and a halogenated solvent. These dispersion media may be used singly or in combination of two or more of them. When the slurry composition is an aqueous slurry, at least one selected from the group consisting of water, a lactam solvent, a nitriles solvent, and an ethers solvent can be used as the dispersion medium. When the slurry composition is a non-aqueous slurry, at least one selected from the group consisting of a lactam solvent, a nitriles solvent, an ethers solvent, an esters solvent, and a halogenated solvent can be used as the dispersion medium.

Examples of the solid electrolyte material forming a solid electrolyte layer include inorganic solid electrolyte materials and organic solid electrolyte materials. Among them, inorganic solid electrolyte materials can be suitably used as the solid electrolyte material from the viewpoint of thermal resistance.

### (Inorganic Solid Electrolyte Material)

The inorganic solid electrolyte material means an electrolyte material in solid form that can migrate ions therein. The inorganic solid electrolyte material does not contain an organic material as a principal ionic conductive material and is therefore clearly differentiated from any organic solid electrolyte material. Furthermore, the inorganic solid electrolyte material is solid in a steady state and, therefore, is not dissociated or released as cations and anions. In this respect, the inorganic solid electrolyte material is clearly differentiated from any inorganic electrolyte salt (such as LiPF₆, LiBF₄, lithium bis(fluorosulfonyl) imide (LiFSl) or LiCl) which is dissociated or released as cations and anions in an electrolytic solution or a polymer. The type of the inorganic solid electrolyte material is not particularly limited so long as it has a conductivity of ions of metal elements belonging to Group I or Group II in the periodic table and those having no electronic conductivity are generally used. When the all-solid-state battery is a lithium-ion secondary battery, the inorganic solid electrolyte material preferably has ionic conductivity of lithium ions.

The inorganic solid electrolyte material may be used by appropriate selection from among solid electrolyte materials commonly used for all-solid-state batteries. Representative examples of the inorganic solid electrolyte material are sulfide-based inorganic solid electrolytes and oxide-based inorganic solid electrolytes and oxide-based inorganic solid electrolytes are preferably used because they are free from risk of production of hydrogen sulfide.

### [Sulfide-Based Inorganic Solid Electrolyte Material]

The sulfide-based inorganic solid electrolyte material is preferably one containing sulfur(S), having ionic conductivity of metals belonging to Group I or Group II in the periodic table, and having electronic insulation. The sulfide-based inorganic solid electrolyte material is preferably one containing at least Li, S, and P as elements and having lithium-ion conductivity, but may contain elements other than Li, S, and P depending on the purpose or circumstances. Examples of the sulfide-based inorganic solid electrolyte material include compounds satisfying the composition represented by Formula (3) below.

Lₐ₁M_{b1}P_{c1}S_{d1}Aₑ₁ Formula (3)

In Formula (3), L represents an element selected from among Li, Na, and K and is preferably Li. M represents an element selected from among B, Zn, Sn, Si, Cu, Ga, Sb, Al, and Ge. A represents an element I, Br, Cl or F. The subscripts a1 to e1 represent the respective relative proportions of elements in the composition and a1:b1:c1:d1:e1 satisfies 1-12:0-5:1:2-12:0-10. The subscript al is preferably 1 to 9 and more preferably 1.5 to 7.5. The subscript b1 is preferably 0 to 3. The subscript d1 is preferably 2.5 to 10 and more preferably 3.0 to 8.5. The subscript e1 is preferably 0 to 5 and more preferably 0 to 3.

The sulfide-based inorganic solid electrolyte material may be amorphous (glass), crystallized (formed of glass ceramics) or partially crystallized. Example of the sulfide-based inorganic solid electrolyte material that can be used include Li—P—S-based glass containing Li, P, and S and Li—P—S-based glass ceramics containing Li, P, and S. Furthermore, the sulfide-based inorganic solid electrolyte material can be produced, for example, by reaction between at least two source materials of lithium sulfide (Li₂S), phosphorus sulfide (such as diphosphorus pentasulfide (P₂S₅)), elemental phosphorus, elemental sulfur, sodium sulfide, hydrogen sulfide, halogenated lithium (such as LiI, LiBr, and LiCl), and sulfides of elements represented by M described above (such as SiS₂, SnS, and GeS₂). The ratio between Li₂S and P₂S₅ in Li—P—S-based glass and Li—P—S-based glass ceramics is, in terms of molar ratio of Li₂S:P₂S₅, preferably 60:40 to 90:10 and more preferably 68:32 to 78:22. By defining the ratio between Li₂S and P₂S₅ within this range, the lithium-ion conductivity can be further increased.

### [Oxide-Based Inorganic Solid Electrolyte Material]

The oxide-based inorganic solid electrolyte material is preferably one containing oxygen atoms (O), having ionic conductivity of metal elements belonging to Group 1 or Group II in the periodic table, and having electronic insulation. Examples of the oxide-based inorganic solid electrolyte material include: LiₓₐLa_{ya}TiO₃ [where za satisfies 0.3≤za≤0.7 and ya satisfies 0.3≤ya≤0.7] (LLT); Li_{xb}La_{yb}Zr_{zb}M^{bb}_{mb}O_{nb} (where M^{bb} is at least one element selected from Al, Mg, Ca, Sr, V, Nb, Ta, Ti, Ge, In, and Sn, xb satisfies 5≤xb≤10, yb satisfies 1≤yb≤4, zb satisfies 1≤zb≤ 4, mb satisfies 0≤mb≤2, and nb satisfies 5≤nb≤ 20); Li_{xc}B_{yc}M^{cc}_{zc}O_{nc} (where M^{cc} is at least one element selected from C, S, Al, Si, Ga, Ge, In, and Sn, xc satisfies 0≤xc≤5, yc satisfies 0≤yc≤1, zc satisfies 0≤zc≤ 1, and nc satisfies 0≤nc≤6); Li_{xd}(Al, Ga)_{yd}(Ti, Ge)_{zd}Si_{ad}P_{md}O_{nd} (where xd satisfies 1≤xd≤3, yd satisfies 0≤yd≤1, zd satisfies 0≤zd≤2, ad satisfies 0≤ad≤1, md satisfies 1≤md≤7, and nd satisfies 3≤nd≤13); Li₍₃₋₂ₓₑ₎ M^{ee}ₓₑD^{ee}O (where xe represents a number of not less than 0 and not more than 0.1, M^{ee} represents a divalent metal atom, and D^{ee} represents a halogen atom or a combination of two or more types of halogen atoms); Li_{xf}Si_{yf}O_{zf} (where xf satisfies 1≤xf≤5, yf satisfies 0<yf≤3, and zf satisfies 1≤zf≤10); Li_{xg}S_{yg}O_{zg} (where xg satisfies 1≤xg≤3, yg satisfies 0<yg≤ 2, and zg satisfies 1≤ zg≤ 10); Li₃BO₃; Li₃BO₃—Li₂SO₄; Li₂O—B₂O₃—P₂O₅; Li₂O—SiO₂; Li₆BaLa₂Ta₂O₁₂; Li₃PO_{(4-3/2w)}N_{w} (where w satisfies w<1); Li_{3.5}Zn_{0.25}GeO₄ having a LISICON (lithium super ionic conductor) crystal structure; La_{0.55}Li_{0.35}TiO₃ having a perovskite crystal structure; LiTi₂P₃O₁₂ having a NASICON (natrium super ionic conductor) crystal structure; Li_{1+xh+yh} (Al, Ga)ₓₕ(Ti, Ge)₂₋ₓₕSi_{yh}P_{3-yh}O₁₂ (where xh satisfies 0≤xh≤1 and yh satisfies 0≤yh≤1); Li₇La₃Zr₂O₁₂ (LLZ) having a garnet crystal structure; titanates having a structure in which a plurality of host layers are laid one on top of another, the host layer being formed so that octahedra each formed of a titanium atom coordinated with six oxygen atoms are two-dimensionally chained while sharing ridges, and lithium ions are intercalated in interlayers between the host layers, titanium sites in the host layers being partially substituted by monovalent to trivalent cations, including LiₓM^{I}_{y}Ti_{1.73}O_{3.7-4}·nH₂O (where M^{I} represents an alkali metal except for lithium, the subscript x is 0.3 to 1.0, the subscript y is 0 to 0.4, and the subscript n is 0 to 2) and LiₓM^{I}_{y}M^{II}_{z}Ti_{1.6}O_{3.7-4}·nH₂O (where M^{I} represents an alkali metal except for lithium, M^{II} represents an alkaline earth metal, the subscript x is 0.3 to 1.0, the subscript y is 0 to 0.4, the subscript z is 0 to 0.4, and the subscript n is 0 to 2); and titanates having a structure in which a plurality of host layers are laid one on top of another, the host layer being formed so that octahedra each formed of a titanium atom coordinated with six oxygen atoms are two-dimensionally chained while sharing ridges, and lithium ions and divalent or higher-valent cations are intercalated in interlayers between the host layers, titanium sites in the host layers being partially substituted by monovalent to trivalent cations, including Li_{0.14}K_{0.05}Al_{0.12}Ti_{1.73}O_{3.7}·1.0H₂O, Li_{0.13}K_{0.04}Mg_{0.16}Ti_{1.73}O_{3.7}·1.7H₂O, and Li_{0.39}K_{0.09}Ba_{0.20}Ti_{1.73}O_{3.9}·1.0H₂O.

Among them, when the binder composition according to the present invention contains a flaky titanic acid compound, the preferred oxide-based inorganic solid electrolyte materials from the viewpoint of further increasing the affinity are: titanates having a structure in which a plurality of host layers are laid one on top of another, the host layer being formed so that octahedra each formed of a titanium atom coordinated with six oxygen atoms are two-dimensionally chained while sharing ridges, and lithium ions are intercalated in interlayers between the host layers, titanium sites in the host layers being partially substituted by monovalent to trivalent cations; and titanates having a structure in which a plurality of host layers are laid one on top of another, the host layer being formed so that octahedra each formed of a titanium atom coordinated with six oxygen atoms are two-dimensionally chained while sharing ridges, and lithium ions and divalent or higher-valent cations are intercalated in interlayers between the host layers, titanium sites in the host layers being partially substituted by monovalent to trivalent cations.

The inorganic solid electrolyte material is preferably in the form of particles. The average particle diameter of particulate inorganic solid electrolyte particles is not particularly limited, but is preferably 0.01 μm or more, more preferably 0.05 μm or more, and even more preferably 0.1 μm or more. The upper limit of the average particle diameter of the particulate inorganic solid electrolyte particles is preferably not more than 20 μm, more preferably not more than 10 μm, and even more preferably not more than 5 μm.

The “average particle diameter” herein refers to a particle diameter at a volume-based cumulative integrated value of 50% in a particle size distribution determined by the laser diffraction and scattering method (a volume-based 50% cumulative particle diameter), i.e., D₅₀ (a median diameter). This volume-based 50% cumulative particle diameter (D₅₀) is a particle diameter at a cumulative value of 50% in a cumulative curve of a particle size distribution determined on a volume basis, the cumulative curve assuming the total volume of particles to be 100%, where during accumulation the number of particles is counted from a smaller size side.

Considering simultaneous pursuit of the battery performance and the effect of reducing the interfacial resistance and maintaining low interfacial resistance, the content of the inorganic solid electrolyte material in the slurry composition is, relative to 100% by mass of solid content, preferably 5% by mass or more and more preferably 70% by mass or more. The upper limit of the content of the inorganic solid electrolyte material in the slurry composition is, from the same viewpoint, preferably not more than 99% by mass and more preferably not more than 95% by mass. The solid content herein refers to components other than the dispersion medium.

However, when the slurry composition contains a positive-electrode active material or a negative-electrode active material, instead of the content of the inorganic solid electrolyte material only, the total content of the positive-electrode active material or the negative-electrode active material and the inorganic solid electrolyte material in the slurry composition is preferably within the above range.

The inorganic solid electrolyte materials may be used singly or in combination of two or more of them.

### <Solid Electrolyte Layer>

A solid electrolyte layer according to the present invention is a solid electrolyte layer formed using the above-described slurry composition and a layer that can conduct ions. Since the solid electrolyte layer has low interfacial resistance between solid particles and so on, it has excellent ionic conductivity.

Examples of the method for forming the solid electrolyte layer include a method of pressing the above-described slurry composition, and a method of applying the slurry composition onto a base material (or through another layer onto a base material) and drying the applied slurry composition to produce a solid electrolyte sheet.

The thickness of the solid electrolyte layer is preferably 0.1 μm to 1,000 μm and more preferably 0.1 μm to 300 μm.

### <All-Solid-State Battery>

An all-solid-state battery according to the present invention is an all-solid-state battery, such as a lithium-ion secondary battery, which includes a positive electrode, a negative electrode, and a solid electrolyte layer disposed between the positive electrode and the negative electrode and formed using the slurry composition according to the present invention.

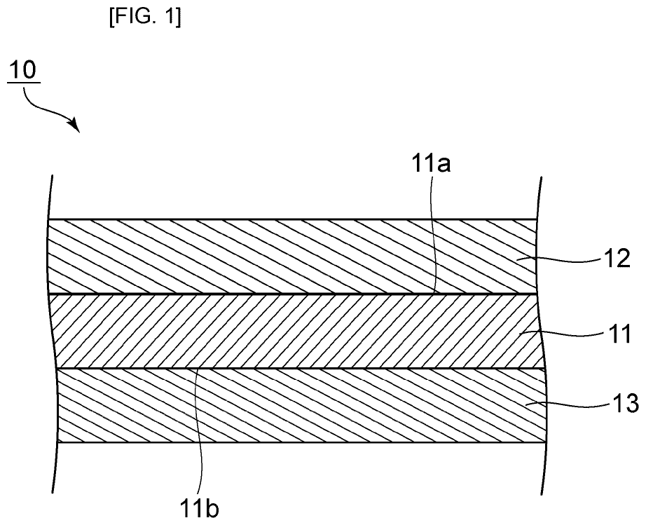

More specifically, FIG. 1 is a schematic cross-sectional view showing a lithium-ion secondary battery according to an embodiment of the present invention.

As shown in FIG. 1, the lithium-ion secondary battery 10 includes a solid electrolyte layer 11, a positive electrode 12, and a negative electrode 13. The solid electrolyte layer 11 has a first principal surface 11a and a second principal surface 11b opposed to each other. The solid electrolyte layer 11 is formed using the above-described slurry composition according to the present invention. The positive electrode 12 is laid on the first principal surface 11a of the solid electrolyte layer 11. The negative electrode 13 is laid on the second principal surface 11b of the solid electrolyte layer 11.

The method for producing the all-solid-state battery according to the present invention is not particularly limited so long as it is a method that can provide the above-described all-solid-state battery, and the same method as any known all-solid-state battery production method can be used. An example is a production method of sequentially laying and pressing a positive electrode, a solid electrolyte layer, and a negative electrode one on top of another to make an electric-generating element, enclosing the electric-generating element in a battery case, and swaging the battery case.

Any general battery case can be used as the battery case for use in the battery according to the present invention. An example of the battery case is a battery case made of stainless steel.

Because of the use of the solid electrolyte layer according to the present invention, the all-solid-state battery according to the present invention can be a highly ionic conductive and high-power battery. In addition, since the solid electrolyte layer is disposed in the all-solid-state battery, it also serves as a separation film and eliminates the need for an existing separation film and, therefore, thickness reduction of the all-solid-state battery can be expected.

Hereinafter, a description will be given of components of the all-solid-state battery according to the present invention.

### (Positive Electrode)

The positive electrode forming part of the all-solid-state battery according to the present invention includes a positive-electrode current collector and a positive-electrode active material layer.

Examples of the material for the positive-electrode current collector include copper, nickel, stainless steel, iron, titanium, aluminum, and aluminum alloy. The positive-electrode current collector is preferably made of aluminum. The thickness and shape of the positive-electrode current collector can be appropriately selected according to the intended use and so on of the all-solid-state battery and, for example, the positive-electrode current collector may have the shape of a planar strip. In the case of a strip-shaped positive-electrode current collector, it can have a first surface and a second surface as the side of the positive-electrode current collector opposite to the first surface. The positive-electrode active material layer can be formed on one or both surfaces of the positive-electrode current collector.

The positive-electrode active material layer is a layer containing a positive-electrode active material and may contain, as necessary, a conductive material and a binder. The positive-electrode active material layer may further contain a solid electrolyte material. When containing the solid electrolyte material, the positive-electrode active material layer can have even higher ionic conductivity. The thickness of the positive-electrode active material layer is preferably 0.1 μm to 1,000 μm.

The type of the positive-electrode active material is not particularly limited so long as it can absorb and release lithium or lithium ions, and examples include lithium cobaltate (LiCoO₂), lithium nickelate (LiNiO₂), lithium manganate (LiMnO₂), lithium nickel cobalt aluminate (such as LiNi_{0.8}Co_{0.15}Al_{0.05}O₂), lithium nickel cobalt manganate (such as LiNi_{1/3}Mn_{1/3}Co_{1/3}O₂ and Li₁₊ₓNi_{1/3}Mn_{1/3}Co_{1/3}O₂ (0≤x<0.3)), spinel oxides (LiM₂O₄ where M=Mn or V), lithium metal phosphates (LiMPO₄ where M=Fe, Mn, Co or Ni), silicate oxides (Li₂MSiO₄ where M=Mn, Fe, Co or Ni), LiNi_{0.5}Mn_{1.5}O₄, and S₈.

The conductive material is mixed for the purpose of increasing the current collecting performance and reducing the contact resistance between the positive-electrode active material layer and the positive-electrode current collector and examples include carbon-based materials, such as vapor-grown carbon fibers (VGCF), coke, carbon black, acetylene black, Ketjen black, graphite, carbon nanofibers, and carbon nanotubes.

The binder is mixed for the purpose of filling voids in the dispersed positive-electrode active material and also binding the positive-electrode active material layer and the positive-electrode current collector together and examples thereof include: polysiloxane, polyalkylene glycol, ethyl-vinyl alcohol copolymer, carboxymethylcellulose (CMC), hydroxypropyl methylcellulose propyl (HPMC), cellulose acetate, polytetrafluoroethylene (PTFE), polyvinylidene fluoride (PVDF), polyvinylidene fluoride-hexafluoropropylene copolymer (PVDF-HFP), polyimide, polyamide, polyamide imide, polyvinyl alcohol, chlorinated polyethylene (CPE), and synthetic rubbers, such as butadiene rubber, isoprene rubber, styrene-butadiene rubber (SBR), styrene-butadiene-styrene copolymer (SBS), styrene-ethylene-butylene-styrene copolymer (SEBS), ethylene-propylene rubber, butyl rubber, chloroprene rubber, acrylonitrile-butadiene rubber, acrylic rubber, silicone rubber, fluoro-rubber and urethane rubber. Alternatively, the flaky metal acid compound described previously may be used as the binder. In this case, the binder composition according to the present invention may contain the flaky metal acid compound described previously, a positive-electrode active material, and, as necessary, a conductive material and may be used to form the positive-electrode active material layer.

In an example of a method for producing a positive electrode, a positive-electrode active material, a conductive material, and a binder are suspended in a solvent to prepare a slurry and the slurry is applied to one surface or both surfaces of a positive-electrode current collector. Next, the applied slurry is dried to obtain a laminate of a positive-electrode active material layer and the positive-electrode current collector. Thereafter, in the method, the laminate is pressed. In another method, a positive-electrode active material, a conductive material, and a binder are mixed and the resultant mixture is molded into pellets. Next, in the method, these pellets are disposed on a positive-electrode current collector.

### (Negative Electrode)

The negative electrode forming part of the battery according to the present invention includes a negative-electrode current collector and a negative-electrode active material layer.

Examples of the material for the negative-electrode current collector include stainless steel, copper, nickel, and carbon. The negative-electrode current collector is preferably made of copper. The thickness and shape of the negative-electrode current collector can be appropriately selected according to the intended use and so on of the all-solid-state battery. For example, the negative-electrode current collector may have the shape of a planar strip. In the case of a strip-shaped current collector, it can have a first surface and a second surface as the side of the current collector opposite to the first surface. The negative-electrode active material layer can be formed on one or both surfaces of the negative-electrode current collector.

The negative-electrode active material layer is a layer containing a negative-electrode active material and may contain, as necessary, a conductive material and a binder. The negative-electrode active material layer may further contain a solid electrolyte material. When containing the solid electrolyte material, the negative-electrode active material layer can have even higher ionic conductivity. The thickness of the negative-electrode active material layer is preferably 0.1 μm to 1,000 μm.

Examples of the material for the negative-electrode active material include metal active materials, carbon active materials, lithium metal, oxides, nitrides, and mixtures of them. The metal active materials include In, Al, Si, and Sn. The carbon active materials include mesocarbon microbeads (MCMB), highly oriented graphite (HOPG), hard carbon, and soft carbon. An example of the oxides is Li₄Ti₅O₁₂. An example of the nitrides is LiCON.

The conductive material is mixed for the purpose of increasing the current collecting performance and reducing the contact resistance between the negative-electrode active material and the negative-electrode current collector and examples include carbon-based materials, such as vapor-grown carbon fibers (VGCF), coke, carbon black, acetylene black, Ketjen black, graphite, carbon nanofibers, and carbon nanotubes.

The binder is mixed for the purpose of filling voids in the dispersed negative-electrode active material and also binding the negative-electrode active material and the negative-electrode current collector together and examples thereof include: polysiloxane, polyalkylene glycol, polyacrylic acid, carboxymethylcellulose (CMC), hydroxypropyl methylcellulose propyl (HPMC), cellulose acetate, polytetrafluoroethylene (PTFE), polyvinylidene fluoride (PVDF), polyvinylidene fluoride-hexafluoropropylene copolymer (PVDF-HFP), polyimide, polyamide, polyamide imide, polyvinyl alcohol, chlorinated polyethylene (CPE), and synthetic rubbers, such as butadiene rubber, isoprene rubber, styrene-butadiene rubber (SBR), styrene-butadiene-styrene copolymer (SBS), styrene-ethylene-butylene-styrene copolymer (SEBS), ethylene-propylene rubber, butyl rubber, chloroprene rubber, acrylonitrile-butadiene rubber, acrylic rubber, silicone rubber, fluoro-rubber and urethane rubber. Alternatively, the flaky metal acid compound described previously may be used as the binder. In this case, the binder composition according to the present invention may contain the flaky metal acid compound described previously, a negative-electrode active material, and, as necessary, a conductive material and may be used to form the negative-electrode active material layer.

In an example of a method for producing a negative electrode, a negative-electrode active material, a conductive material, and a binder are suspended in a solvent to prepare a slurry and the slurry is applied to one surface or both surfaces of a negative-electrode current collector. Next, the applied slurry is dried to obtain a laminate of a negative-electrode active material layer and the negative-electrode current collector. Thereafter, in the method, the laminate is pressed. In another method, a negative-electrode active material, a conductive material, and a binder are mixed and the resultant mixture is molded into pellets. Next, in the method, these pellets are disposed on a negative-electrode current collector.

### EXAMPLES

The present invention will be described below in further detail with reference to specific examples. The present invention is not at all limited by the following examples and modifications and variations may be appropriately made therein without changing the gist of the invention.

Source titanates and solid electrolyte materials used in Examples and Comparative Examples were measured in terms of average particle diameter with a laser diffraction particle size distribution measurement device (SALD-2100 manufactured by Shimadzu Corporation). Furthermore, the composition formulae were confirmed with an ICP-AES analyzer (SPS 5100 manufactured by SII Nanotechnologies Inc.) and a thermogravimetric apparatus (EXSTAR 6000 TG/DTA 6300 manufactured by SII Nanotechnologies Inc.).

The measurement of the average length of each flaky metal acid compound was made by drying a sol of the flaky metal acid compound and measuring the sol with a scanning electron microscope (S4800 manufactured by Hitachi High-Tech Corporation). The composition formulae of the flaky metal acid compounds were confirmed with an ICP-AES analyzer (Agilent 5110 Type VDV manufactured by Agilent Technologies, Inc.).

### <Source Titanate>

The source titanate used in Examples and Comparative Examples is as follows.

### (Source Titanate A)

A titanate having a layered crystal structure that contains potassium ions in the interlayers and lithium ions in the host layers (potassium lithium titanate K_{0.6}Li_{0.27}Ti_{1.73}O_{3.9} having an average particle diameter of 3 μm and an average thickness of 1.5 μm)

### <Solid Electrolyte Material>

The solid electrolyte materials used in Examples and Comparative Examples are as follows.

### (LLTO)

Li_{0.33}La_{0.55}TiO₃ (LLTO, manufactured by Toshima Manufacturing Co., Ltd., average particle diameter: 5 μm)

### (LTO)

LTO was produced in the following manner. First, an amount of 65 g of source titanate A was dispersed into 1 kg of deionized water and 50.4 g of 95% sulfuric acid was added to the liquid. The mixed liquid was stirred at 20° C. for an hour and then subjected to separation and the separated product was washed with water. This process was repeated twice to exchange potassium ions and lithium ions in the source titanate for hydrogen ions or hydronium ions, thus obtaining titanic acid having a layered crystal structure. An amount of 50 g of the titanic acid having a layered crystal structure was dispersed into 200 g of deionized water and 324 g of 10% aqueous solution of lithium hydroxide monohydrate was added to the liquid with heating to 70° C. and stirring. The liquid was stirred at 70° C. for three hours and then a residue was filtered out. The residue was well washed with hot water at 70° C. and then dried in air at 110° C. for 12 hours, thus obtaining a powdered lepidocrocite titanate (LTO). The average particle diameter and composition formula of the obtained LTO were 3 μm and K_{0.07}Li_{1.0}Ti_{1.73}O₄·0.97H₂O, respectively.

### <Binder Composition>

### (Nanosheet Sol A)

An amount of 650 g of source titanate A was dispersed into 10 kg of deionized water and 504 g of 95% sulfuric acid was added to the liquid. The mixed liquid was stirred at 20° C. for an hour and then subjected to separation and the separated product was washed with water. This process was repeated twice to exchange potassium ions and lithium ions in the source titanate for hydrogen ions or hydronium ions, thus obtaining titanic acid having a layered crystal structure. Deionized water was added to the titanic acid having a layered crystal structure to reach a total amount of 16 kg and an amine aqueous solution in which 175 g of ethylamine (1.07 equivalents relative to the titanic acid having a layered crystal structure) and 3.7 kg of deionized water were mixed was further added, followed by stirring at 20° C. for 12 hours to peel the interlayers of the layered crystal structure, thus obtaining a sol of a flaky metal acid compound composed of a flaky titanic acid and a basic compound. After a lapse of 12 hours, the sol was passed through a sieve with 38-μm openings, thus obtaining a nanosheet sol A in which the solid content concentration of the flaky metal acid compound was 3% by mass. The average length of the flaky metal acid compound was 3 μm.

### (Binder A)

An amount of 400 g of deionized water was added to 400 g of the nanosheet sol A and the mixture was stirred. An aqueous solution in which 3.188 g of lithium hydroxide monohydrate (1.2 equivalents relative to the flaky metal acid compound) was dissolved in 396.812 g of deionized water was further added to the mixture. The mixture was stirred at 20° C. for 24 hours and then washed by centrifugation (three times with a centrifugal force of 4450 Xg for 10 minutes) and deionized water was then added to the mixture, thus obtaining a binder A in which the solid content concentration of the flaky metal acid compound was 18% by mass. The average length of the flaky metal acid compound was 3 μm. The composition formula of the flaky metal acid compound was K_{0.07}Li_{0.61}Ti_{1.73}O_{3.8}.

### (Binder B)

An amount of 42.7 g of deionized water was added to 0.8695 g of the nanosheet sol A and the mixture was stirred. An amount of 0.0621 g of lithium bis(trifluoromethane sulfonyl) imide (1.6 equivalents relative to the flaky metal acid compound) was added to the mixture. The mixture was stirred at 20° C. for 24 hours and then washed by centrifugation (three times with a centrifugal force of 4450 Xg for 10 minutes) and deionized water was then added to the mixture, thus obtaining a binder B in which the solid content concentration of the flaky metal acid compound was 18% by mass. The average length of the flaky metal acid compound was 3 μm. The composition formula of the flaky metal acid compound was K_{0.07}Li_{0.38}Ti_{1.73}O_{3.7}.

### (Binder C)

Deionized water was added to 1.2717 g of the nanosheet sol A to reach a total amount of 40 g and dilute nitric acid was further added to the mixture to reach a pH of 2.1. Thereafter, a cyclohexane solution of 0.3574 g of oleyl phosphate was slowly added to the mixture to form a two-layered liquid. The liquid was stirred at 20° C. for four days as it was held in a two-layered state. Then, an organic layer was recovered from the liquid and washed by centrifugation (three times with a centrifugal force of 17790 Xg for ten minutes). Thereafter, a white solid settled at the bottom of the centrifugal tube was obtained. The obtained solid was mixed into NMP (N-methyl-2-pyrrolidone), thus obtaining a nanosheet sol B in which the solid content concentration of a flaky metal acid compound surface-treated with oleyl phosphate was 3%.

An amount of 42.7 mL of NMP and 0.0643 g of lithium bis(trifluoromethane sulfonyl) imide (1.7 equivalents relative to the flaky metal acid compound) were added to 0.8446 g of the nanosheet sol B and the mixture was stirred at 20° C. for 24 hours. After the stirring, the mixture was washed by centrifugation (three times with a centrifugal force of 4450 Xg for 10 minutes) and NMP was then added to the mixture, thus obtaining a binder C in which the solid content concentration of the flaky metal acid compound was 18% by mass. The average length of the flaky metal acid compound was 3 μm.

### (Binder D)

An amount of 20 g of polyvinylidene fluoride (trade name: KF polymer, manufactured by Kureha Corporation) was dissolved in 180 g of NMP, thus obtaining a binder D in which the solid content concentration of polyvinylidene fluoride was 10% by mass.

### <Measurement of Impedance>

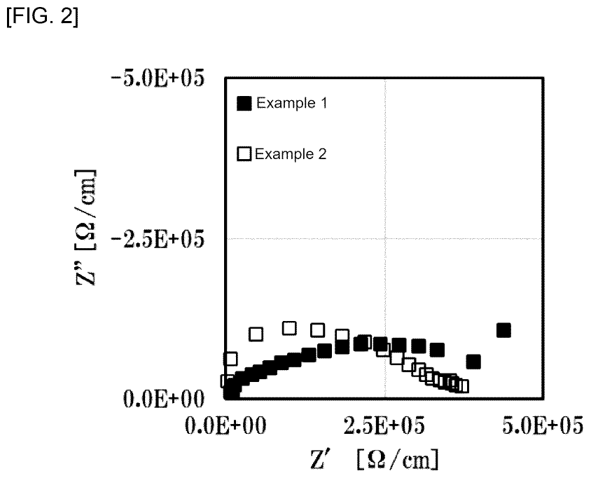

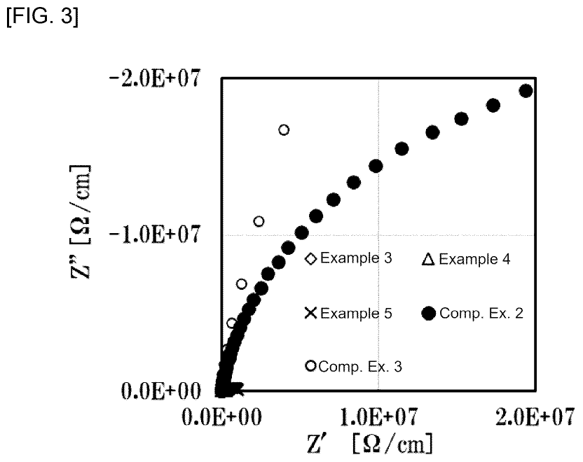

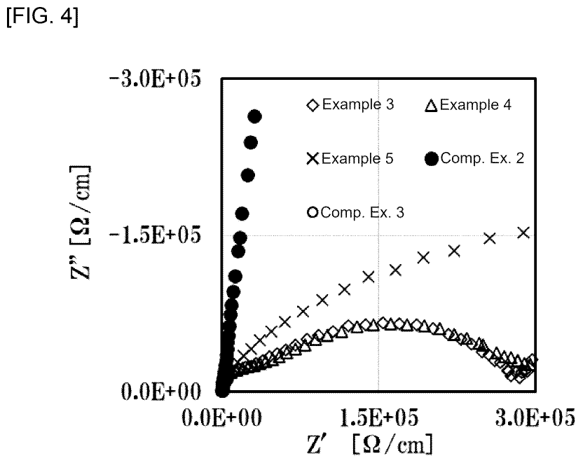

The solid electrolyte material and the binder composition in each example were mixed well in a mortar to give the solid content ratio described in Table 1 and the mixture was put into a mold and pressed therein at 7.9 MPa. After the pressing, the resultant pellet was demolded and dried at 60° C. for 24 hours. A Pt—Pd electrode (with a diameter of 5 mm) was vapor-deposited onto the dried pellet (with a thickness of 1 mm) and the pellet was measured in terms of impedance in a range of 1 MHz to 50 Hz by the AC impedance method with no application of pressure (measurement device: CompactStat manufactured by Ivium Technologies). FIGS. 2 to 4 show Nyquist diagrams. FIG. 2 shows the results of Examples 1 and 2 and FIG. 3 shows the results of Examples 3 to 5 and Comparative Examples 2 and 3. For the purpose of confirmation of Examples 3 to 5, FIG. 4 shows FIG. 3 on a larger scale. As for Comparative Examples 1 and 4, the pellets were fragile and, therefore, cannot be measured in terms of impedance.

TABLE 1

| | Solid Electrolyte Material | | Binder Composition | | |
|---|---|---|---|---|---|
| Example 1 | LLTO | 100 parts by mass | Binder A | 31 | parts by mass |
| Example 2 | LTO | 100 parts by mass | Binder A | 31 | parts by mass |
| Example 3 | LLTO | 100 parts by mass | Nanosheet sol A | 6 | parts by mass |
| Example 4 | LLTO | 100 parts by mass | Binder B | 6 | parts by mass |
| Example 5 | LLTO | 100 parts by mass | Binder C | 6 | parts by mass |
| Comp. Ex. 1 | LLTO | 100 parts by mass | Binder D | 6 | parts by mass |
| Comp. Ex. 2 | LLTO | 100 parts by mass | Binder D | 18 | parts by mass |
| Comp. Ex. 3 | LTO | 100 parts by mass | Binder D | 6 | parts by mass |
| Comp. Ex. 4 | LLTO | 100 parts by mass | Source Titanate A | 6 | parts by mass |

As shown in the Nyquist diagrams of FIGS. 3 and 4, the curves in Examples 3 to 5 have tighter arcs than those in Comparative Examples 2 and 3. In this case, the Nyquist diagrams show semicircular features at higher frequencies and spike features at shorter frequencies and it can be considered that the smaller the semicircle at higher frequencies, the higher the ionic conductivity. Therefore, it can be seen that Examples 3 to 5 in which the binder composition according to the present invention containing the flaky metal acid compound was used had higher ionic conductivity than Comparative Examples 2 and 3 in which the binder composition containing polyvinylidene fluoride (PVDF) was used. Since Comparative Example 1 having the same amount of binder mixed as Examples 3 to 5 could not be measured in term of impedance because of its fragile pellet, this shows that the flaky metal acid compound for use in the binder composition according to the present invention can bind the solid electrolyte material even in small amount. In other words, it can be seen that the use of the binder composition according to the present invention can increase not only the ionic conductivity but also the bindability.

As shown in the Nyquist diagram of FIG. 2, the curve in Example 2 has a tighter arc than that in Example 1. This result shows that a combination of the binder composition according to the present invention containing the flaky metal acid compound and LTO can further increase the ionic conductivity.

### REFERENCE SIGNS LIST

10 . . . lithium-ion secondary battery
11 . . . solid electrolyte layer
11a first principal surface
11b second principal surface
12 . . . positive electrode
13 . . . negative electrode

1. A binder composition for an all-solid-state battery, the binder composition being used in formation of an all-solid-state battery and containing a flaky metal acid compound, the flaky metal acid compound being composed of: a flaky metal acid; and a basic compound and/or a lithium salt.

2. The binder composition for an all-solid-state battery according to claim 1, wherein the flaky metal acid compound has an average length of not less than 0.5 μm and not more than 50 μm.

3. The binder composition for an all-solid-state battery according to claim 1, wherein the flaky metal acid is titanic acid.

4. The binder composition for an all-solid-state battery according to claim 1, wherein the flaky metal acid compound is formed by allowing the basic compound to act on a metal acid having a layered crystal structure to swell and/or peel an interlayer of the layered crystal structure.

5. The binder composition for an all-solid-state battery according to claim 1, wherein the flaky metal acid compound is formed by allowing the basic compound to act on a metal acid having a layered crystal structure to obtain a compound in which an interlayer of the layered crystal structure is swelled and/or peeled and allowing the lithium salt to act on the obtained compound.

6. The binder composition for an all-solid-state battery according to claim 1, the binder composition being substantially free of non-ionic conductive polymer compound.

7. The binder composition for an all-solid-state battery according to claim 1, the binder composition further containing a dispersion medium.

8. The binder composition for an all-solid-state battery according to claim 7, wherein the dispersion medium is at least one selected from the group consisting of water, a lactam solvent, a nitriles solvent, an ethers solvent, a ketones solvent, an esters solvent, and a halogenated solvent.

9. The binder composition for an all-solid-state battery according to claim 7, wherein a content of the dispersion medium is not less than 100 parts by mass and not more than 10,000 parts by mass relative to 100 parts by mass of the flaky metal acid compound.

10. A slurry composition for an all-solid-state battery, the slurry composition containing a solid electrolyte material and the binder composition for an all-solid-state battery according to claim 7.

11. The slurry composition for an all-solid-state battery according to claim 10, wherein the solid electrolyte material is an inorganic solid electrolyte material.

12. The slurry composition for an all-solid-state battery according to claim 11, wherein the solid electrolyte material is: a titanate having a structure in which a plurality of host layers are laid one on top of another, the host layer being formed so that octahedra each formed of a titanium atom coordinated with six oxygen atoms are two-dimensionally chained while sharing ridges, and lithium ions are intercalated in interlayers between the host layers, titanium sites in the host layers being partially substituted by monovalent to trivalent cations; or a titanate having a structure in which a plurality of host layers are laid one on top of another, the host layer being formed so that octahedra each formed of a titanium atom coordinated with six oxygen atoms are two-dimensionally chained while sharing ridges, and lithium ions and divalent or higher-valent cations are intercalated in interlayers between the host layers, titanium sites in the host layers being partially substituted by monovalent to trivalent cations.

13. A solid electrolyte layer formed using the slurry composition for an all-solid-state battery according to claim 10.

14. A lithium-ion secondary battery comprising the solid electrolyte layer according to claim 13.
